(19) United States
(12) Patent Application Publication
(10) Pub. No.: US 2013/0288653 A1
(43) Pub. Date: Oct. 31, 2013

(54) NETWORK DEVICE AND METHOD FOR ADJUSTING BANDWIDTH

(71) Applicants: HONG FU JIN PRECISION INDUSTRY (ShenZhen) CO., LTD., (US); HON HAI PRECISION INDUSTRY CO., LTD., New Taipei (TW)

(72) Inventor: WEN-JI ZHAO, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/775,105

(22) Filed: Feb. 22, 2013

(30) Foreign Application Priority Data
Apr. 26, 2012 (CN) 201210126319.X

(51) Int. Cl. H04W 72/04

(52) U.S. Cl. CPC H04W 72/04
USPC 455/416

(57) ABSTRACT

A network device adjusts a bandwidth of a conference call according to a mode of the network device. The network device detects whether the mode of the network device during the conference call is in a silent mode or in a conversation mode according to a conversation condition of the network device. The network device decreases the bandwidth of the conference call in the silent mode, and increases the bandwidth of the conference call in the conversation mode.

### BACKGROUND

1. Technical Field

Embodiments of the present disclosure generally relate to network devices, and more particularly to a method for adjusting a bandwidth of a conference call according to mode of a network device.

2. Description of Related Art

In most conference call situations, one participant is speaking and other participants are listening in a conference call. However, bandwidths allocated to the speaking and listening participants are the same, which is not an optimum allocation of the bandwidth. Therefore, it is necessary to provide a network device and an optimum method for allocating the bandwidth.

### BRIEF DESCRIPTION OF THE DRAWINGS

FIG. 1 is a schematic diagram of one embodiment of an application environment and functional modules of a network device in accordance with the present disclosure.

FIG. 2 is a flowchart of one embodiment of bandwidth adjusting method in accordance with the present disclosure.

FIG. 3 is a flowchart of one embodiment of a method for decreasing bandwidth in a silent mode in accordance with the present disclosure.

FIG. 4 is a flowchart of one embodiment of a method for increasing bandwidth in a conversation mode in accordance with the present disclosure.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used hereinafter, refers to logic embodied in hardware or firmware, or to a collection of software instructions, written in a programming language, such as, for example, JAVA, C, or assembly. One or more software instructions in the modules may be embedded in firmware such as in an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

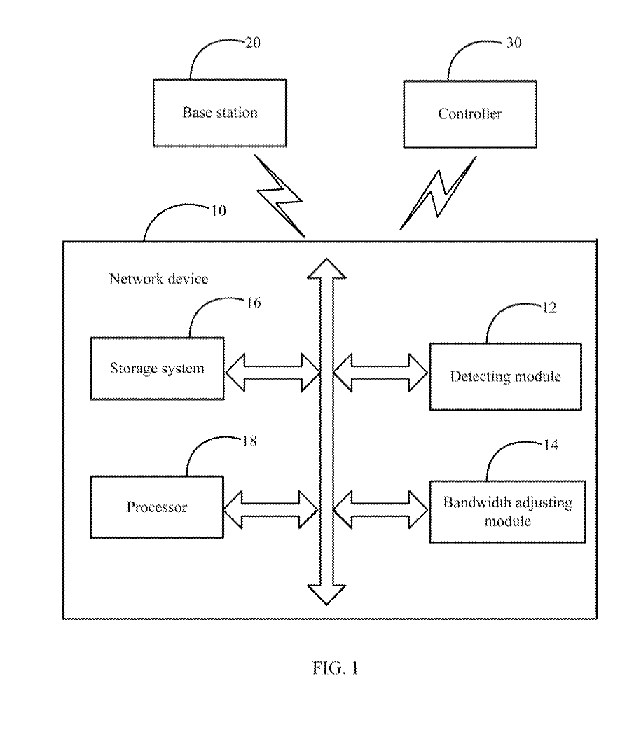

FIG. 1 is a schematic diagram of an application environment and functional modules of one embodiment of a network device 10 in accordance with the present disclosure. In one embodiment, the network device 10 acts as a participant in a conference call and communicates with other network devices by a controller 30. In detail, the network device 10 sends audio data generated by itself to the controller 30. The controller receives the audio data generated by the network device 10 and processes voice data generated by the network device 10 by audio mixing, then sends processed audio data to the other network devices. In one embodiment, the network device 10 may be a Worldwide Interoperability For Microwave Access(WIMAX) terminal. The network device 10 can dynamically adjust bandwidth of the conference call according to a mode of the network device 10. That is, the network device 10 can decrease the bandwidth of the conference call when the network device 10 enters a silent mode, and the network device also can increase the bandwidth obtained from a base station 20 for the conference call when the network device 10 enters a conversation mode.

In one embodiment, the network device 10 includes a detecting module 12, a bandwidth adjusting module 14, a storage system 16, and a processor 18. The modules 12 and 14 may comprise computerized code in the form of one or more programs that are stored in the storage system 16. The computerized code includes instructions that are executed by the processor 18 to provide functions for the modules 12 and 14. In one example, the storage system 16 may include a hard disk drive, a flash memory, a cache or another computerized memory.

In one embodiment, the bandwidth adjusting module 14 sets a priority of a service flow provided for the conference call higher than other service flows not provided for the conference call. The service flow provided for the conference call defines that the service flow is used to transmit video data or audio data during the conference call. The other service flows not provided the conference call defines that the other service flows are used to do other things, such as seeing a film or pictures, or browsing a web page. Setting the priority ensures that the service flow provided for the conference call can be transmitted first.

The detecting module 12 detects the mode of the network device 10 during the conference call real time according to a conversation condition of the network device 10. The network device 10 includes two modes, the silent mode and the conversation mode. The silent mode defines that the network device 10 just receives audio data from the controller, but does not send audio data to the controller. The conversation mode defines that the network device 10 not only receives audio data from the controller but also sends audio data to the controller. The detecting module 12 records a current bandwidth value of the conference call when the network device 10 enters the silent mode, and calculates an actual requirement bandwidth value of the conference call in the silent mode, and further calculates a bandwidth adjustment value according to the current bandwidth value and the actual requirement bandwidth value in the silent mode. The bandwidth adjusting module 14 sends a dynamic service change request(DSC-REQ) packet to the base station 20 based on the bandwidth adjustment value for decreasing the bandwidth of the conference call in the silent mode. In one embodiment, a decrease value of the bandwidth of the conference call is the bandwidth adjustment value.

In one embodiment, the bandwidth adjustment module 14 may decrease the bandwidth of the conference call in an uplink direction. Because an uplink data is less than a downlink data in the silent mode, it is optimum to decrease the bandwidth in the uplink direction.

In one embodiment, the bandwidth adjusting module 14 sends another DSC-REQ packet to the base station 20 based on the bandwidth adjustment value for recovering the bandwidth of the conference call when the network device 10 enters the conversation mode. In detail, the bandwidth adjusting module 14 recovers the bandwidth of the conference call by increasing the bandwidth according to the bandwidth adjustment value. Furthermore, the bandwidth adjusting module 14 allocates bandwidth provided by the base station 20 to the conference call in the conversation mode when the base station 20 can provide enough bandwidth.

In one embodiment, the bandwidth adjusting module 14 sends a special DSC-REQ packet to the base station 20 to obtain the bandwidth from the other service flows not provided for the conference call according to the priority of the service flow when the base station 20 can not provide enough bandwidth for the conference call. The special DSC-REQ packet includes a service flow identity(SFID), a connection identity(CID), a type of the other service flows, a bandwidth value of the other service flows. The bandwidth adjusting module 14 allocates the bandwidth obtained from the other service flows to the conference call in the conversation mode.

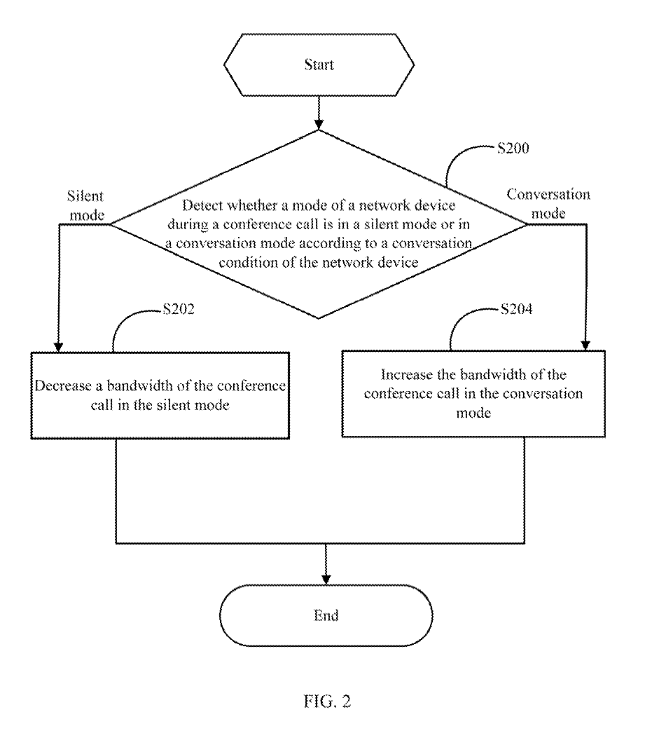

FIG. 2 is a flowchart of one embodiment of bandwidth adjusting method of a conference call according to mode of the network device 10 in accordance with the present disclosure. In the embodiment, the bandwidth adjusting method is executed by the functional modules of FIG. 1 in the manner of following.

In block S200, the detecting module 12 detects whether the mode of the network device 10 is the silent mode or the conversation mode according to a conversation condition of the network device 10. The detecting module 12 determines that the network device 10 is in the silent mode when the network device 10 just receives audio data from the controller but does not send audio data to the controller. The detecting module 12 further determines that the network device 10 is in the conversation mode when the network device 10 not only receives the audio data from the controller but also sends the audio data to the controller.

In block S202, the bandwidth adjusting module 14 sends a DSC-REQ packet to the base station 20 for decreasing the bandwidth of the conference call in the silent mode.

In block S204, the bandwidth adjusting module 14 sends another DSC-REQ packet to the base station 20 for increasing the bandwidth of the conference call in the conversation mode.

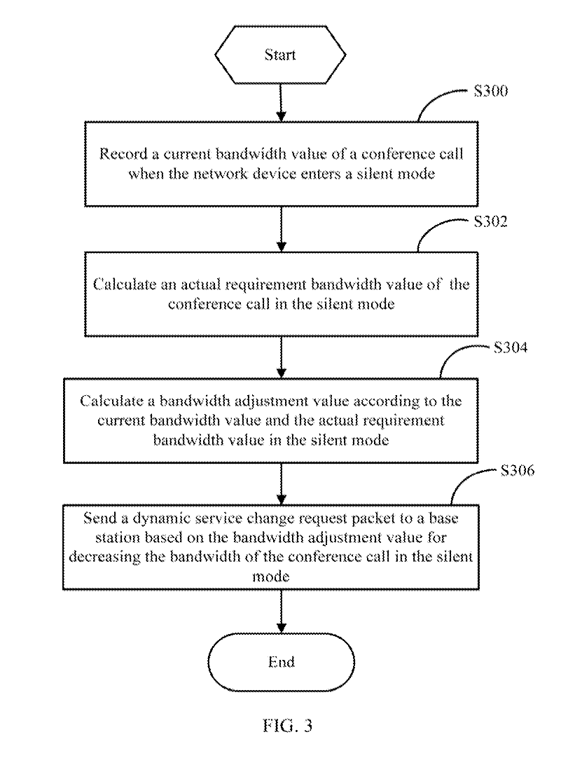

FIG. 3 shows a flowchart of a method for decreasing a bandwidth of the conference call in the silent mode in accordance with the present disclosure. In the embodiment, the bandwidth decreasing method in the silent mode is executed by the functional modules of FIG. 1 in the manner of following.

In block S300, the bandwidth adjusting module 14 records a current bandwidth value of the conference call when the network device 10 enters the silent mode.

In block S302, the bandwidth adjusting module 14 calculates an actual requirement bandwidth value of the conference call in the silent mode.

In block S304, the bandwidth adjusting module 14 calculates a bandwidth adjustment value according to the current bandwidth value and the actual requirement bandwidth value in the silent mode.

In block S306, the bandwidth adjusting module 14 sends a DSC-REQ packet to the base station 20 based on the bandwidth adjustment value for decreasing the bandwidth of the conference call in the silent mode. A decrease value of the bandwidth of the conference call is the bandwidth adjustment value. In one embodiment, the bandwidth adjusting module 14 may decrease the bandwidth of the conference call in an uplink direction. Because the uplink data is less than the downlink data in the silent mode, it is optimum to decrease the bandwidth in the uplink direction.

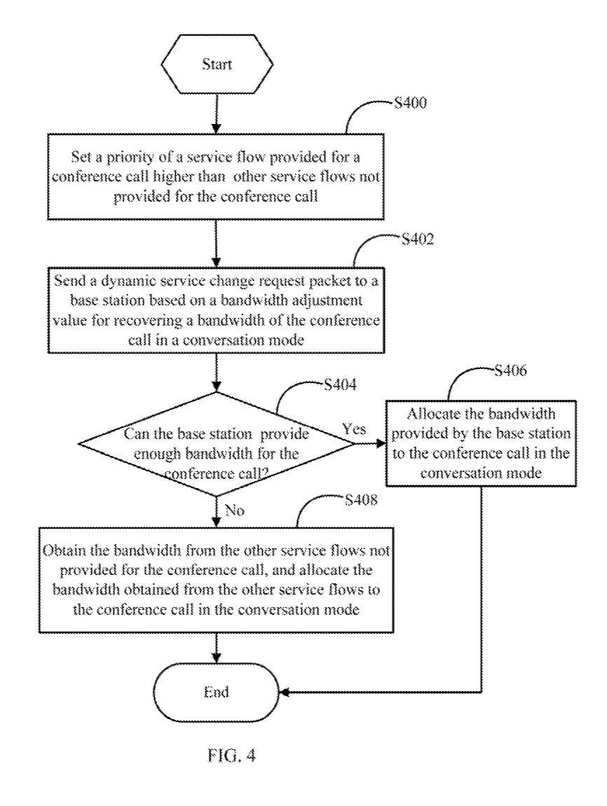

FIG. 4 shows a flowchart of a method for increasing a bandwidth of the conference call in the conversation mode in accordance with the present disclosure. In the embodiment, the bandwidth increasing method in the conversation mode is also executed by the functional modules of FIG. 1 in the manner of following.

In block S400, the bandwidth adjusting module 14 sets a priority of a service flow provided for the conference call higher than other service flows not provided for the conference call.

In block S402, the bandwidth adjusting module 14 sends a dynamic service change request packet to the base station 20 based on a bandwidth adjusting value for recovering a bandwidth of the conference call in the conversation mode. In one embodiment, the bandwidth adjusting module 14 recovers the bandwidth of the conference call by increasing the bandwidth according to the bandwidth adjustment value.

In block S404, the bandwidth adjusting module 14 determines whether the base station 20 can provide enough bandwidth for the network device 10 for recovering the bandwidth of the conference call in the conversation mode.

In block S406, the bandwidth adjusting module 14 allocates the bandwidth provided by the base station 20 to the conference call in the conversation mode when the base station 20 can provide enough bandwidth for the conference call.

In block S408, the bandwidth adjusting module 14 sends a special DSC-REQ packet to the base station 20 for obtaining bandwidth from the other service flows which have a low priority when the base station 20 can not provide enough bandwidth. The special DSC-REQ packet includes a SFID, a CID, a type of the other service flows, a bandwidth value of the other service flows. The bandwidth adjusting module 14 further allocates the bandwidth obtained from the other service flows to the conference call for recovering the bandwidth in the conversation mode.

The bandwidth adjusting method and the network device 10 in the present disclosure can adjust bandwidth of the conference call according to current mode of the network device 10 instantly during the conference call, which makes a bandwidth optimization utilization.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A network device, comprising:
a processor;
a storage system electronically connected to the processor;
one or more programs that are stored in the storage system and are executed by the processor, comprising:
a detecting module, detecting whether a mode of the network device during a conference call is in a silent mode or a conversation mode according to a conversation condition of the network device; and
a bandwidth adjusting module, decreasing bandwidth of the conference call in the silent mode, and increasing the bandwidth of the conference call in the conversation mode.

2. The network device as claimed in claim 1, wherein the bandwidth adjusting module further records a current bandwidth value of the conference call when the network device enters the silent mode, calculates an actual requirement bandwidth value of the conference call in the silent mode, and calculates a bandwidth adjustment value according to the current bandwidth value and the actual requirement bandwidth value in the silent mode, sends a dynamic service change request packet to a base station based on the bandwidth adjustment value for decreasing the bandwidth of the conference call in the silent mode.

3. The network device as claimed in claim 2, wherein the bandwidth adjusting module further sends another dynamic service change request packet to the base station based on the bandwidth adjustment value to recover the bandwidth of the conference call in the conversation mode, and allocates available bandwidth provided by the base station to the conference call in the conversation mode.

4. The network device as claimed in claim 3, wherein the bandwidth adjusting module further sets a priority of a service flow provided for the conference call higher than other service flows not provided for the conference call.

5. The network device as claimed in claim 4, wherein the bandwidth adjusting module further obtains bandwidth from the other service flows not provided for the conference call when the available bandwidth provided by the base station is less than the bandwidth adjustment value, and allocates the bandwidth obtained from the other service flows to the conference call in the conversation mode.

6. A bandwidth adjusting method, adjusting a bandwidth of a conference call according to a mode of the network device, the method comprising:
detecting whether the mode of the network device during the conference call is a silent mode or a conversation mode according to a conversation condition of the network device;
decreasing the bandwidth of the conference call in the silent mode; and
increasing the bandwidth of the conference call in the conversation mode.

7. The bandwidth adjusting method as claimed in claim 6, further comprising:
recording a current bandwidth value of the conference call when the network device enters the silent mode;
calculating an actual requirement bandwidth value of the conference call in the silent mode;
calculating a bandwidth adjustment value according to the current bandwidth value and the actual requirement bandwidth value in the silent mode; and
sending a dynamic service change request packet to a base station based on the bandwidth adjustment value for decreasing the bandwidth of the conference call in the silent mode.

8. The bandwidth adjusting method as claimed in claim 7, further comprising:
sending another dynamic service change request packet to the base station based on the bandwidth adjustment value to recover the bandwidth of the conference call in the conversation mode; and
allocating available bandwidth provided by the base station to the conference call in the conversation mode.

9. The bandwidth adjusting method as claimed in claim 8, further comprising:
setting a priority of a service flow provided for the conference call higher than other service flows not provided for the conference call.

10. The bandwidth adjusting method as claimed in claim 9, further comprising:
Obtaining a bandwidth from the other service flows not provided for the conference call when the available bandwidth provided by the base station is less than the bandwidth adjustment value; and
allocating the bandwidth obtained from the other service flows to the conference call in the conversation mode.
